(19) United States
(12) Patent Application Publication
(10) Pub. No.: US 2018/0016875 A1
(43) Pub. Date: Jan. 18, 2018

(54) SYSTEMS AND METHODS FOR REAL-TIME CONTROLLING OF CUTTINGS REINJECTION OPERATIONS

(71) Applicant: M.I. L.L.C., Houston, TX (US)

(72) Inventors: Talgat Shokanov, Houston, TX (US); Carla Vizzini, Houston, TX (US); Salamat Gumarov, Abu Dhabi (AE)

(21) Appl. No.: 15/208,322

(22) Filed: Jul. 12, 2016

(51) Int. Cl. E21B 41/00; E21B 21/06; E21B 21/01; G06F 17/50; E21B 47/06

(52) U.S. Cl. CPC E21B 41/0057; G06F 17/5009; E21B 47/065; E21B 21/01; E21B 21/066; E21B 47/06

(57) ABSTRACT

A method may include receiving, via a processor, data related to properties associated with injecting a slurry into a subsurface region of the Earth from one or more sensors disposed within the subsurface region. The method may then determine whether the data is within a threshold of simulated data determined based on a simulation of injecting the slurry into the subsurface region over a simulated period of time. The simulation is generated using a geomechanical model having mechanical properties associated with the subsurface region. The method may then generate an updated geomechanical model based on the data and automatically send commands to adjust operations of components that control an injection of the slurry into the subsurface region based on the updated geomechanical model.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light.

A wellbore drilled into a geological formation may be targeted to produce hydrocarbons from certain zones of the geological formation. As the wellbore is being drilled, different waste materials including drilling cuttings (i.e., pieces of a formation dislodged by the cutting action of teeth on a drill bit) are produced from the formations. In some cases, surface storage and disposal options for the waste material are limited or unavailable. As such, the waste or a portion of the waste may be reinjected into the formation through a cuttings reinjection (CRI) well. However, effectively disposing the waste materials while maintaining the structural integrity of the wellbore and the formation is now recognized as a challenge.

### BRIEF DESCRIPTION OF THE DRAWINGS

Various aspects of this disclosure may be better understood upon reading the following detailed description and upon reference to the drawings in which:

FIG. 1 illustrates a schematic diagram of a cuttings reinjection (CRI) system employed in reinjecting waste material into a wellbore, in accordance with embodiments presented herein;

FIG. 2 illustrates a block diagram depicting a communication network between various components of the CRI system of FIG. 1 and a computing system, in accordance with embodiments presented herein;

FIG. 3 illustrates a block diagram of example components that may be part of the CRI control system within the CRI system of FIG. 1, in accordance with embodiments presented herein;

FIG. 4 illustrates a flow chart of a method for automatically adjusting a CRI operation based on data acquired from sensors monitoring various surface and/or subsurface properties related to a wellbore, in accordance with embodiments presented herein; and

FIG. 5 illustrates an example data flow chart that illustrates various data processing operations involved in adjusting a CRI operation based on example input data acquired from sensors monitoring various surface and/or subsurface properties related to a wellbore, in accordance with embodiments presented herein.

### DETAILED DESCRIPTION

One or more specific embodiments of the present disclosure will be described below. These described embodiments are examples of the presently disclosed techniques. Additionally, in an effort to provide a concise description of these embodiments, some features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned above, when drilling in geological formations, various waste materials including drilling cuttings (i.e., pieces of a formation dislodged by the cutting action of teeth on a drill bit) are produced and may be reinjected into the formation through a cuttings reinjection (CRI) operation. Typically, a CRI operation involves the collection and transportation of cuttings from solid control equipment on a rig to a slurrification unit. The slurrification unit subsequently may grind the cuttings into small particles in the presence of a fluid to create a slurry (e.g., waste slurry). The slurry may be then transferred to a slurry holding tank for conditioning. The conditioned slurry may be pumped or injected into an injection formation by creating fractures within the injection formation under high pressure. In some instances, the conditioned slurry may be injected intermittently in batches into the injection formation, such that the batch process involves injecting similar volumes of conditioned slurry, and waiting for a period of time (e.g., shut-in time) after each injection for the conditioned slurry to settle into the formation.

The batch processing (i.e., injecting conditioned slurry into the injection formation and then waiting for a period of time after the injection) allows the fractures to close and dissipate the build-up of pressure in the injection formation. However, in some cases, the pressure in the injection formation may increases due to the presence of the injected solids (i.e., the solids present in the drill cuttings slurry). As a result, new branched fractures may be created during subsequent batch injections aligned with the azimuths of a preferred fracture plane. Accordingly, in some embodiments of the present disclosure, real time measurements related to surface and subsurface regions of the Earth where the cuttings reinjection (CRI) operation is being performed may be acquired and used to determine how the reinjection operation should be performed. By automatically adjusting the CRI operation based on real-time measurements related to surface and subsurface properties of the injection formation, the conditioned slurry may interact with the injection formation to maximize an amount of the conditioned slurry that can be injected into the injection formation.

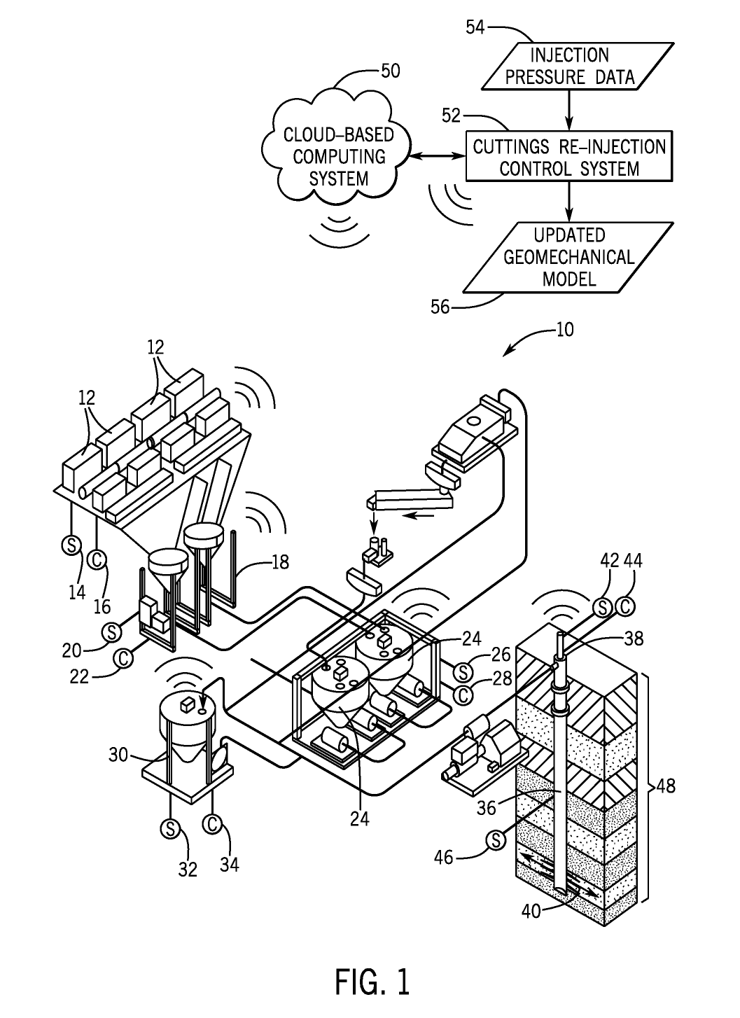

By way of introduction, FIG. 1 schematically illustrates a cuttings reinjection (CRI) system 10 for reinjecting waste material (e.g., drill cuttings) into a wellbore or into injection formation within the wellbore, in accordance with embodiments presented herein. In particular, the CRI system 10 of FIG. 1 includes various types of equipment that may be employed to perform a CRI operation. In the example of FIG. 1, the depicted CRI system 10 may correspond to an onshore cuttings reinjection site, but it should be understood that the presently disclosed techniques are not limited to onshore sites. Instead, the embodiments of the present disclosure may be implemented in any suitable site, such as offshore sites, land-based sites, remote (e.g., subsea, artic, jungle etc.) sites, and the like.

In some embodiments, the CRI system 10 may include a solids control equipment 12 (e.g., one or more shale shakers) that may remove or filter solids (e.g., drill cuttings) from drilling or wellbore fluids extracted from a wellbore or a subsurface region of the Earth. The solids control equipment 12 may include one or more sensors 14 that may monitor various properties (e.g., speed, acceleration, deck angle, voltage, current, power) related to the operation of the solids control equipment 12. The solids control equipment 12 may also include one or more controllers 16 that may control the operation of the solids control equipment 12 based on data received from the sensors 14, commands received from a remote control system, and the like.

The separated solids and cuttings output by the solids control equipment 12 may be directed to a collection area 18, which may store the separated solids into various storage containers. In some embodiments, the collection area 18 may include one or more sensors 20 that may detect an amount or volume of solids in each storage component of the collection area 18. The collection area 18 may also include various pipelines, pumps, and other equipment that may transfer the waste solids to other equipment. To control the transfer of the waste solids to other equipment, the collection area 18 may include one or more controllers 22 that may control the operation of various components (e.g., pumps, valves) within the collection area 18 to cause the waste solids located in various storage components of the collection area 18 to move to other equipment in the CRI system 10. For example, the waste solids may be transported to one or more mixing tanks 24.

In addition to waste solids, the mixing tank 24 may also receive various types of fluids that may be used to prepare a slurry to be injected into a injection formation. That is, the mixing tank 24 may mix fluids, such as sea water, fresh water, oily drains, production water, other fluids, and other components, with the waste solids to create the injectable slurry. The mixing tanks 24 may include one or more sensors 26 (e.g., viscometer, densitometer) that may measure various properties regarding the slurry rheology, the fluids provided for the slurry, and the like. For example, the sensors 26 may measure density properties and viscosity properties of the slurry or the any of the other mixing fluids. The sensors 26 may also measure an amount or volume of each fluid (e.g., slurry, mixing fluids), the temperature of each fluid, the density of each fluid, and the pressure of each fluid in the mixing tanks 24, and the like. In addition to the sensors 26, the mixing tank 24 may also include one or more controllers 28 that may control the operation of the mixing tank 24, the components (e.g., pumps, valves, motors) that operate the mixing tank 24, and the like. In some embodiments, the CRI system 10 may utilize two (or more) different types of mixing tanks 24. For instance, one mixing tank 24 may prepare a slurry with coarse solids and the second mixing tank 24 may prepare a slurry with finer solids. In this situation, the one or more controllers 28 may control the transfer or distribution of each respective slurry to various equipment disposed within the CRI system 10.

The slurry may be transferred to one or more holding tanks 30 before being injected. The holding tanks 30 may also include one or more sensors 32 and one or more controllers 34 similar to those discussed above. As such, the sensors 32 may measure various properties relating to the slurry stored in the holding tank 30, and the controllers 34 may control various equipment (e.g., pumps, valves) that may be used to transport the stored slurry into an injection formation 40.

The holding tank 30 may be in fluid communication with a wellbore 36 via a high pressure line to transport the stored slurry. In one embodiment, the wellbore 36 may include an injection system 38 that may control how the slurry is injected into the wellbore 36 and the injection formation 40. The injection system 38 may include one or more sensors 42 that may measure various properties related to the wellbore 36, the slurry being injected into the wellbore 36, the operation of various equipment used to inject the slurry into the wellbore 36, and the like. For example, the sensors 42 may measure pressure at or near a wellhead of the wellbore 36, pressure at inputs and/or outputs of equipment, such as a high pressure pump, used to inject the slurry into the wellbore 36, an injection rate of the high-pressure pump, density of the slurry, viscosity of the slurry, volume of the slurry, flow rate of the slurry and the like.

The injection system 38 may also include one or more controllers 44 that may control certain operations related to injecting the slurry into the wellbore 36. For example, the controllers 44 may control an injection rate of the slurry by controlling a speed at which a high-pressure pump used to inject the slurry operates. The controllers 44 may similarly control a volume of the slurry injected into the wellbore 36 by controlling the batch process in which the high-pressure pump may inject different volumes of the slurry into the wellbore 36. Similarly, the controllers 44 may also control a volume of viscous pill, a volume of overflush, a shut-in time for the wellbore 36, a particle size within the slurry, a density of the slurry, a viscosity of the slurry, and the like by controlling the operation of various components within the injection system that may affect the listed properties.

It should be noted that the various areas described above as being part of the CRI system 10 may be physically coupled together via a network of pipelines that connect each area. The network of pipelines may include sensors distributed throughout the network to indicate various properties (e.g., viscosity, density, flow rate) regarding a number of different fluids that may be distributed via the network in real-time. In addition, the network of pipelines may also include certain machines, such as pumps and controllable valves that may control where the different types of fluids may be directed within the CRI system 10.

In some embodiments, the wellbore 36 may include one or more sensors 46 disposed at various locations within a subsurface region 48 of the Earth. For instance, one of the sensors 46 may be disposed at the bottom of the wellbore adjacent to injection interval 36 and may measure the downhole pressure of the wellbore 36, at various perforations within the wellbore 36, at the injection formations, and the like. In addition, the sensors 46 may be disposed within several annulus of the wellbore 36 and may measure the pressure between a casing of the wellbore and geological formations.

With the foregoing in mind, each of the sensors 14, 20, 26, 32, 42, 46 and each of the controllers 16, 22, 28, 34, 44 may be communicatively coupled to one or more of each other, a computing system 50, a cuttings reinjection (CRI) control system 52, or any other suitable computing device via a wired or wireless medium. As such, the data acquired by the sensors 14, 20, 26, 32, 42, 46 may be transmitted to the computing system 50 and/or the CRI control system 52 for processing and analysis to determine more efficient ways to perform the CRI operation. As discussed herein, the CRI operation may refer to any function described above as being performed by various equipment within the CRI system 10 of FIG. 1. As such, the CRI operation may include controlling aspects related to the separation of waste solid from drilling fluids, transporting the separated solids or any other fluid throughout the CRI system, mixing the slurry, storing the slurry, injecting the slurry into the wellbore 36, and the like.

After receiving the information via the sensors 14, 20, 26, 32, 42, 46, the computing system 50 and/or the CRI control system 52 may analyze the information and send commands to the controllers 16, 22, 28, 34, 44 to control the operation of various machines and components within the CRI system 10 to perform the CRI operation based on their analysis. In this way, the CRI operation may continuously be adjusted to maximize the amount of the slurry deposited within the injection formations 40, avoid undesired events from occurring within the wellbore 36, and the like.

In one embodiment, the computing system 50 may include a number of computers that may be connected through a real-time communication network, such as the Internet and/or may be cloud-based. As such, large-scale analysis operations may be distributed over the computers that make up the computing system 50. Generally, the computers or computing devices provided by the computing system 50 may be dedicated to performing various types of complex and time-consuming analysis and modeling that may include analyzing a large amount of data and generating simulations and/or models described herein.

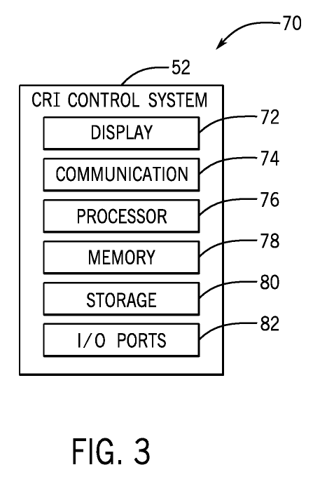

In addition to being communicatively coupled to the sensors and controllers described above, the computing system 50 may be communicatively coupled to the CRI control system 52 via a wired or wireless medium. The CRI control system 52 may be a processor-based computing device that may perform one or more of the techniques described herein. As such, the CRI control system 52 may be a general-purpose computer, a laptop computer, a mobile computing device, a tablet computing device, and the like. Additional details with regard to the CRI control system 52 will be discussed below with reference to FIG. 3.

When performing the CRI operation, in one embodiment, the computing system 50 or the CRI control system 52 may receive or generate an initial geomechanical model 54 that described various properties of the subsurface region 48 of the Earth where the waste material may be deposited. In one embodiment, the geomechanical model 54 may describe various mechanical parameters of various layers in the subsurface region 48 of the Earth. As such, the geomechanical model 54 may identify the locations of various geological layers of rocks and formation within the subsurface region 48. Moreover, the geomechanical model 54 may specify mechanical properties of the geological layers, such as stresses (e.g., amount of force associated with breaking a formation), a Young's modulus value (e.g., amount of force associated with propagating a fracture), leak off (e.g., a distance from fracture fluids may travel into formation), a formation coefficient for each geological layer, pore pressure for each geological layer, a fluid pressure inside pores of each geological layer, vertical stresses for each geological layer, and the like.

In addition to providing the mechanical properties associated with the geological layers of the subsurface region 48, the geomechanical model 54 may provide fracture modeling in a fracture domain with regard to various fractures in the subsurface region 48 over the course of a simulated CRI operation. As such, the geomechanical model 54 may provide information (e.g., sensitivity analysis) related to certain variables within the subsurface region 48 over the course of the simulated CRI operation. For instance, the information may include details with regard to when solids are expected to appear inside an injection zone (e.g., injection formation 40), when and where liquids may leak into a formation, when pressures inside the wellbore 36 may exceed a threshold, how downhole pressure may change over the course of the simulated CRI operation, and the like.

The geomechanical model 54 may be generated based on geological maps and well logs associated with the subsurface region 48, empirical data related to other subsurface regions that have similar properties as the subsurface region 48, and the like. In any case, although the initial geomechanical model 54 may indicate how various properties of the wellbore and the subsurface region 48 may change over the course of the simulated CRI operation, the actual properties simulated by the geomechanical model 54 may not change in accordance to the geomechanical model 54. As such, in one embodiment, the CRI control system 52 or any other suitable computing system (e.g., the computing system 50) may use real-time data acquired from the sensors 14, 20, 26, 32, 42, 46 to verify certain simulated outputs of the geomechanical model 52. As used herein, real-time data refers to data acquired via the sensors 14, 20, 26, 32, 42, 46 and transmitted to the CRI control system 52 at near instantaneous speed, as commonly understood by those skilled in the art.

Based on the acquired real-time data, the CRI control system 52 may generate an updated geomechanical model 56 that may more accurately represent the behavior of the subsurface region 48 and the process of the CRI operation. Additionally, the CRI control system 52 may use the updated geomechanical model 56 to determine how certain aspects of the CRI operation should be adjusted to maximize the amount of the slurry that can be injected into the subsurface region 48, to avoid creating undesired fractures, maintaining the structural integrity (e.g., pressure, stresses) of the subsurface region 48, and the like. Upon determining how the CRI operation should be adjusted, the CRI control system 52 may send commands to the controllers 16, 22, 28, 34, 44 to implement the adjusted CRI operation.

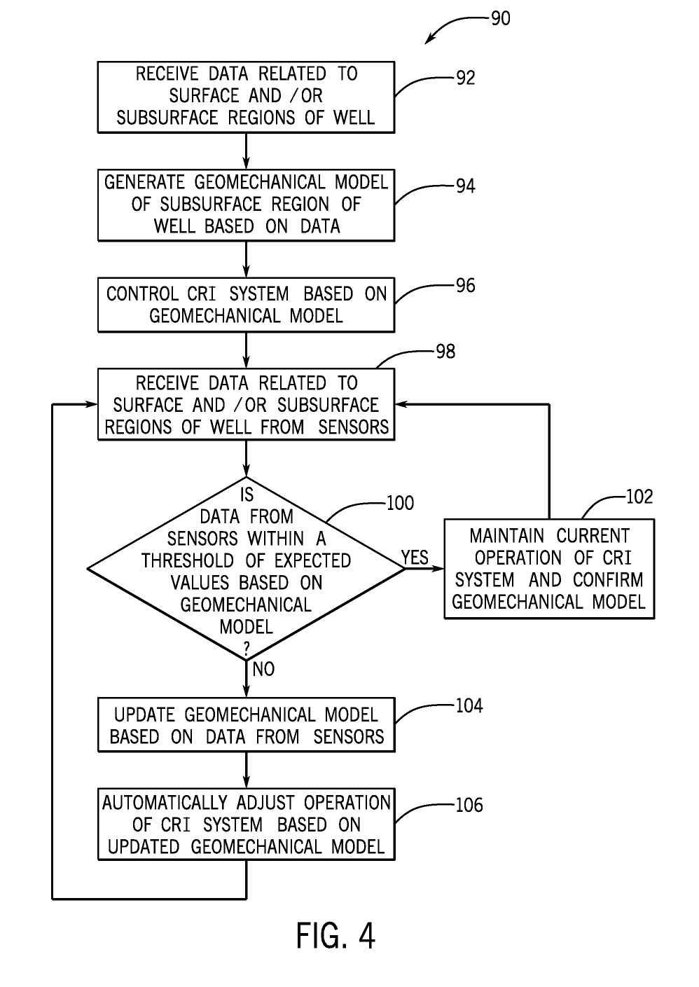

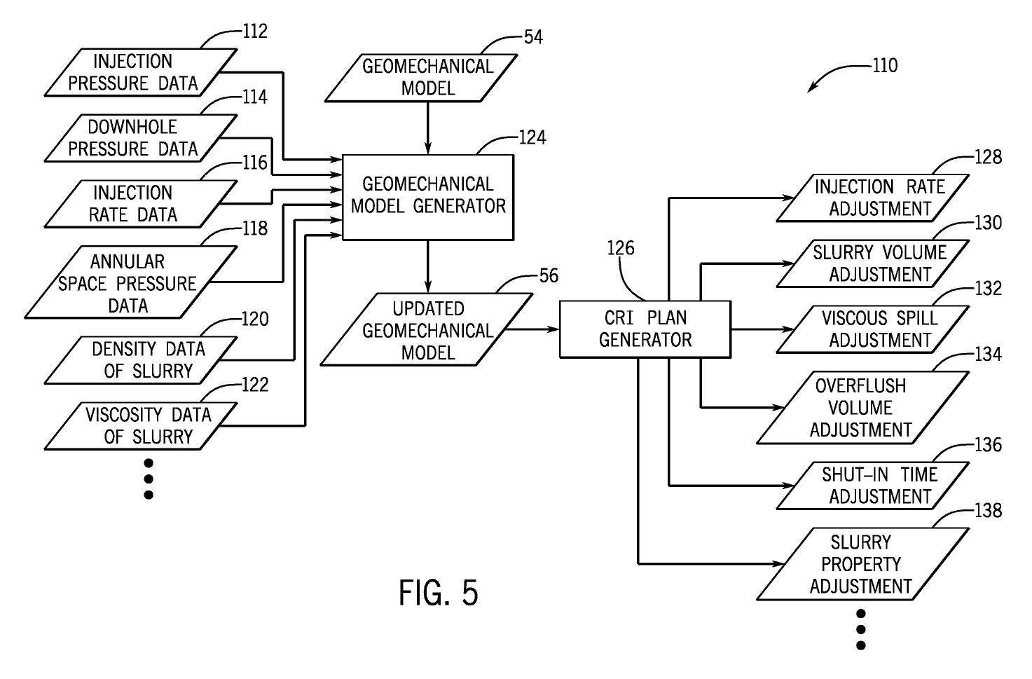

By generating the updated geomechanical model 56 based on the real-time data, the CRI control system 52 efficiently corrects for uncertainties present in the geomechanical model 54. Moreover, the CRI control system 52 may use its computing resources more efficiently by verifying the expected or simulated outputs with actual data provided via the CRI system 10. In this way, the presently disclosed techniques for updating the geomechanical model and controlling the CRI operation in view of the updated model provides an improvement with regard to the CRI control system 52 or any other suitable computing device determining the geomechanical model 56. As such, the presently disclosed systems and techniques are directed to a specific implementation of a solution to a problem in the software arts related to updating a simulation or model. Additional details with regard to how the CRI control system 52 may automatically adjust the CRI operation based on real-time data related to the CRI system 10 will be discussed below with reference to FIGS. 4 and 5.

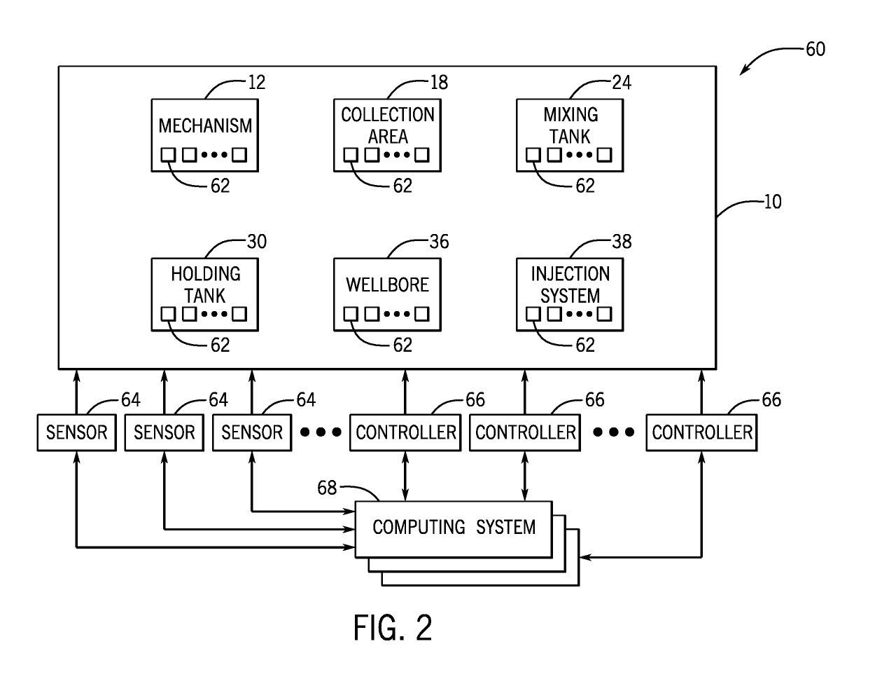

FIG. 2 illustrates a block diagram depicting a communication network 60 between various components of the CRI system of FIG. 1 and a computing system, in accordance with embodiments presented herein. As shown in FIG. 2, the communication network 60 may include the components of the CRI system 10, such as the solids control equipment 12, the collection area 18, the mixing tank 24, the holding tank 30, the wellbore 36, the injection system 38, and the like. Generally, the solids control equipment 12, the collection area 18, the mixing tank 24, the holding tank 30, the wellbore 36, and the injection system 38 may include various types of equipment 62 that may be used to assist with some operation. The equipment 62 may include pumps, mixers, motors, conveyors, valves, injection pumps (e.g., high pressure pumps), and various other types of machines that may be employed in the CRI system 10 to perform the CRI operation.

In certain embodiments, the equipment 62 and other components of the collection area 18, the mixing tank 24, the holding tank 30, the wellbore 36, and the injection system 38 may be communicatively coupled to various sensors 64 and various controllers 66. The sensors 64 may include any suitable sensing circuit that measures certain aspects related to the flow of fluids, the amount of materials stored, various operating characteristics (e.g., speed, voltage, current, temperatures, pressure) related to the equipment 62, various properties related to the subsurface region 48, and the like. As such, the sensors 64 may include the sensors 14, 20, 26, 32, 42, 46 described above, along with other types of sensors. The controllers 66 may include any suitable controller or processor-based computing system that may control the operation of the equipment 62. As such, the controllers 66 may include the controllers 16, 22, 28, 34, 44 described above, along with other types of controllers.

The sensors 64 and the controllers 66 may be communicatively coupled to a computing system 68, which may analyze data acquired via the sensors 64 and send commands to adjust the operations of the equipment 62 via the controllers 66. As such, the computing system 68 may include the computing system 50, the CRI control system 52, or both.

FIG. 3 illustrates a detailed block diagram 70 of example components in the CRI control system 52 that may be used to perform various methods and techniques described herein. It should be noted that the components depicted in block diagram 70 are example components and the CRI control system 52 may include other components or may not include all of the components described herein. Moreover, it should be noted that the computer devices that make up the computing system 50 may each include some or all of the components described herein. In addition, each of the controllers 16, 22, 28, 34, 44 of the CRI system 10, the controllers 66 of the communication network 60, and the computing system 68 of the communication network 60 may also include some or all of the components described with respect to FIG. 3.

Referring now to FIG. 3, the CRI control system 52 may include a display component 72, communication component 74, a processor 76, a memory 78, a storage 80, input/output (I/O) ports 82, and the like. The display component 72 may be used to display various images, models, or data generated by the CRI control system 52, such as a graphical user interface (GUI) for operating the CRI control system 52. The display component 72 may be any suitable type of display, such as a liquid crystal display (LCD), plasma display, or an organic light emitting diode (OLED) display, for example. Additionally, in one embodiment, the display component 72 may be provided in conjunction with a touch-sensitive mechanism (e.g., a touch screen) that may function as part of a control interface for the CRI control system 52.

The communication component 74 may be a wireless or wired communication component that may facilitate communication between the CRI control system 52, the computing system 50, the sensors 14, 20, 26, 32, 42, 46, the controllers 16, 22, 28, 34, 44, and the like. In one embodiment, the CRI control system 52 may use the communication component 74 to communicatively couple to the various components of the CRI system 10 via a real-time communication network such as the Internet, various types of industrial communication network protocols, and the like. In addition, the communication system 74 may transmit data received by the CRI control system 52 via the computing system 50, the sensors 14, 20, 26, 32, 42, 46, the controllers 16, 22, 28, 34, 44, and the like to any suitable computing system capable of receiving real-time data. The communication system 74 may also be capable of receiving data in real-time via the computing system 50, the sensors 14, 20, 26, 32, 42, 46, the controllers 16, 22, 28, 34, 44, and the like. As such, in some embodiments, the communication component 74 facilitates continuously transmission of data or continuously reception of data such that data acquired by another electronic device is made available at near instantaneous speeds.

The processor 76 may be any type of computer processor or microprocessor capable of executing computer-executable code. The processor 76 may also include multiple processors that may perform the operations described below.

The memory 78 and the storage 80 may be any suitable articles of manufacture that can serve as media to store processor-executable code, data, or the like. These articles of manufacture may represent computer-readable media (i.e., any suitable form of memory or storage) that may store the processor-executable code used by the processor 76 to perform the presently disclosed techniques. The memory 78 and the storage 80 may also be used to store the data, analysis of the data, and the like. The memory 78 and the storage 80 may represent non-transitory computer-readable media (i.e., any suitable form of memory or storage) that may store the processor-executable code used by the processor 76 to perform various techniques described herein. It should be noted that non-transitory merely indicates that the media is tangible and not a signal.

The input/output (I/O) ports 82 may be interfaces that may couple to I/O modules that may enable the CRI control system 52 to communicate with various devices in the CRI system 10. As such, the I/O ports 82 may enable various devices to connect to the CRI control system 52 via a network or the like. The I/O ports 82 may also couple to I/O devices such as keyboards, mice, etc. that may be used to interact with the CRI control system 52.

Keeping the foregoing in mind, FIG. 4 illustrates a flow chart of a method 90 for automatically adjusting a CRI operation based on data acquired from sensors monitoring various surface and/or subsurface properties related to the wellbore 36. Although the discussion of the method 90 below will be described in a particular order, it should be noted that the method 90 may be performed in any suitable order. Moreover, for the purposes of discussion, the following description of the method 90 will be discussed as being performed by the CRI control system 52, but it should be understood that the method 90 may be performed by any suitable computing system, including the controllers 66 and the computing system 68 described above with respect to FIG. 2.

Referring now to FIG. 4, at block 92, the CRI control system 52 may receive data related to surface properties and/or subsurface properties (e.g., pressure, temperature) of the wellbore 36. In one embodiment, the data received at block 92 may include geological maps and well logs associated with the subsurface region 48, empirical data related to other subsurface regions that have similar properties as the subsurface region 48, seismic data associated with the subsurface region 78, and the like.

At block 94, the CRI control system 52 may generate the geomechanical model 54 based on the data received at block 92. As such, the geomechanical model 54 may represent various expected mechanical parameters of certain layers in the subsurface region 48 of the Earth. At block 96, the CRI control system 52 may send one or more commands to the controllers 66 to control the operation of the equipment 62 in a certain manner to perform a CRI operation based on the geomechanical model 54. That is, the CRI control system 52 may generate a CRI operation plan that details a desired composition of the slurry to be injected into the wellbore 36, a desired volume of the slurry, desired density of the slurry, desired viscosity of the slurry, a desired average particle size within the slurry, an injection rate to use to inject the slurry, a plan with regard to the batch process for injecting the slurry, and the like. After generating the CRI operation plan, the CRI control system 52 may send commands to the controllers 66 or directly to the equipment 62 to implement the CRI operation plan.

After the CRI operation has started, the CRI control system 52, at block 98, may begin continuously receiving data from the sensors 64. The real-time data received at block 98 may include data acquired via the sensors 64 and may be related to properties regarding the surface and the subsurface region 48 of the Earth. That is, the data may describe real-time conditions regarding the site in which the slurry is being reinjected into the injection formations 40. For example, FIG. 5 illustrates a data flow chart 110 that lists example inputs that the CRI control system 52 may receive via the sensors 64. As illustrated in FIG. 5, the CRI control system 52 may receive injection pressure data 112 that indicates a pressure of the slurry being injected into the wellbore 36, a pressure measurement at a wellhead disposed on the wellbore 36, a pressure setting of the high-pressure pump employed to inject the slurry at the surface, and the like.

The data received via the sensors 64 may also include downhole pressure data 114, which may correspond to a pressure measurement of sensors disposed within the wellbore 36. The acquired data may also include injection rate data 116 that corresponds to a setting or operation of the high-pressure pump used to inject the slurry into the wellbore 36. In one embodiment, the injection rate data 116 may include a schedule of times in which the slurry is slated to be injected with respect to a batch process.

The sensors 64 may also provide data related to annular space pressure data 118, which may be acquired via sensors disposed within an annular space of the wellbore 36. In addition, the sensors 64 may provide information related to the density (e.g., density data 120) and the viscosity (e.g., viscosity data 122) of the slurry when the slurry is being mixed in the mixing tank 24, stored in the holding tank 30, being injected into the wellbore 36 via the injection system 38, and the like.

In some embodiments, the data received at block 98 may also include current operational settings (e.g., speed, desired particle size, slurry composition, injection rate, slurry volume) of the various equipment 62 within the CRI system 10. The current operational settings may be provided via the sensors 64 or the controller 66 that control the operation of the equipment 62.

Returning to the method 90 of FIG. 4, at block 100, the CRI control system 52 may determine whether the data acquired at block 98 is within a threshold (e.g., 10%) of expected values according to the geomechanical model 54. That is, the geomechanical model 54 may include simulated values regarding various properties of the CRI system 10 over a simulated period of time. For instance, the CRI control system 52 may use the geomechanical model 54 to determine simulated values for the injection pressure data 112, the downhole pressure data 114, the injection rate data 116, the annular space pressure data 118, the density data 120, the viscosity data 122, and the like at various points in time during the CRI operation.

If the data acquired via the sensors 64 at block 98 are within the threshold of the corresponding simulated values, the CRI control system 52 may proceed to block 102. At block 102, the CRI control system 52 may maintain the current operation of the CRI system 10 in accordance with the CRI operation plan that corresponds to block 96. The CRI control system 52 may also confirm that the geomechanical model 54 is accurate at block 102. As such, the CRI control system 52 may use the confirmation of the geomechanical model 54 to improve predictions and simulations in later generated simulations and models. After confirming the geomechanical model 54, the CRI control system 52 may return to block 98 and continue receiving data acquired by the sensors 64. In some embodiments, the CRI control system 52 may continuously update the geomechanical model 54 based on the real-time data received via the sensors 64 regardless of whether the data is within the threshold or not.

If, however, the data acquired via the sensors 64 at block 98 are not within the threshold of the corresponding simulated values, the CRI control system 52 may proceed to block 104. At block 104, the CRI control system 52 may update the geomechanical model 54 based on the real-time data received at block 98. Referring briefly to the data flow chart 110 of FIG. 5, at block 102, the CRI control system 52 may use at least a portion of the data acquired via the sensors 64 as an input into a geomechanical model generator 124. The geomechanical model generator 124 may be a software module or application that generates the updated geomechanical model 56 based on the real-time data acquired via the sensors 64. As such, the CRI control system 52 may continuously update the geomechanical model 56 based on the data continuously acquired by the sensors 64. In one embodiment, the geomechanical model generator 124 may receive the initial geomechanical model 54 used to simulate expected values related to the CRI system 10 and adjust or modify the geomechanical model 54 to match the data received via the sensors 64.

By continuously generating the updated geomechanical model 56 based on real-time data, the CRI control system 52 may more accurately predict the behavior of the slurry as it is being injected into the injection formation 40. Moreover, the CRI control system 52 may, at block 106, automatically or continuously adjust the operation of the CRI system 10 or the equipment 62 of the CRI system 10 based on the updated geomechanical model 56, which may also be continuously updated. That is, after the geomechanical model 56 is generated based on the real-time data acquired via the sensors 64, the CRI control system 52 may use the updated geomechanical model 56 to analyze how the continued operation of the equipment 62 may affect the CRI operation. Based on this analysis, the CRI control system 52 may generate a CRI operation plan to improve the efficiency of the CRI operation. For example, the CRI operation plan may include a schedule of batch processes for injecting the waste slurry into the injection formation 40, an injection rate to inject the waste slurry, and the like.

Referring again to the data flow chart 110 of FIG. 5, the CRI control system 52 may employ a software module or application, such as the CRI plan generator 126, to determine how the equipment 62 should operate based on the updated geomechanical model 56. In one embodiment, the CRI plan generator 126 may output certain parameter adjustments with regard the operation of the CRI system 10 to improve the efficiency of the CRI operation. For instance, the CRI plan generator 126 may output an injection rate adjustment 128 for the equipment 62 of the injection system 38. That is, the CRI control system 52 may adjust the rate in which the slurry is being injected into the wellbore 36 based on the updated CRI plan generated by the CRI plan generator 126. In one embodiment, the injection rate may be adjusted by sending a command to the controller 44 of the injection system 38 to modify a rate in which a corresponding high-pressure pump may be pumping the slurry into the wellbore 36.

Other adjustments to the operation of the CRI system 10 may include a slurry volume adjustment 130, a viscous pill adjustment 132, an overflush volume adjustment 134, a shut-in time adjustment 136, a slurry property adjustment 138, and the like. The slurry volume adjustment may include increasing or decreasing the amount of slurry being injected into the wellbore 36 by the injection system 38. Decreasing the volume of slurry injected into the well prior to overflushing the wellbore may be recommended when a near-wellbore packing of solids is observed from pressure response and analysis. The volume of viscous pill and overflush water can be increased to enhance the near-wellbore fracturing area clean-up and propagation of sufficient size hydraulic fracture further beyond the near-wellbore high stress zone. The shut-in time can be extended in cases when additional shut-in pressure fall-off information will be useful for deeper understanding and accurate evaluation of fracturing process and changes detected from the latest performed injections.

The slurry property adjustment 138 may include modifying the average particle size within the slurry, the density of the slurry, the viscosity of the slurry, or the like. In some embodiments, the properties of the slurry may be adjusted by modifying the operation of the solids control equipment 12, the mixing tank 24, or the injection system 38. That is, CRI control system 52 may send commands to open valves to dilute the slurry with other fluids, send commands to machines to grind the waste materials, and the like at various parts of the CRI system 10 to achieve a desired slurry property adjustment 138.

Referring again to the method 90 of FIG. 4, after the CRI control system 52 adjusts the operation of the equipment 62 in the CRI system 10 at block 106, the CRI control system 52 may return to block 98 and continue receiving real-time data from the sensors 66. As such, the CRI control system 52 may continuously update the updated geomechanical model 56 until the measured data sufficiently matches (e.g., within a threshold) the simulated data. In this way, the CRI control system 10 manages the operation of the equipment 62 of the CRI system 10 in real-time, and thus maximizes the environmental benefit of disposing waste material into the injection formation 40.

The specific embodiments described above have been shown by way of example, and it should be understood that these embodiments may be susceptible to various modifications and alternative forms. It should be further understood that the claims are not intended to be limited to the particular forms disclosed, but rather to cover modifications, equivalents, and alternatives falling within the spirit and scope of this disclosure.

1. A method, comprising:
receiving data related to one or more properties associated with injecting a slurry into a subsurface region of the Earth from one or more sensors, wherein the slurry comprises waste material;
determining whether the data is within a threshold of simulated data determined based on a simulation of injecting the slurry into the subsurface region, wherein the simulation is generated using a geomechanical model comprising one or more mechanical properties associated with the subsurface region;
generating an updated geomechanical model based on the data; and
automatically adjusting an operation of the injection of the slurry into the subsurface region based on the updated geomechanical model.

2. The method of claim 1, wherein the one or more properties comprise a downhole pressure and temperature associated with a wellbore within the subsurface region, one or more pressures associated with one or more locations within an annular space of the wellbore, an injection pressure that corresponds to the slurry as the slurry is being injected into the subsurface region, a wellhead pressure, a pressure setting of a pump configured to inject the slurry into the subsurface region, a density of the slurry, a viscosity of the slurry, or any combination thereof.

3. The method of claim 1, comprising confirming, via the one or more processors, that the geomechanical model is accurate when the data is within the threshold of the simulated data.

4. The method of claim 1, wherein the one or more sensors measure a parameter of a first operation of a mechanism configured to filter solids from a drilling fluid extracted from a wellbore, a second operation of one or more pumps configured to distribute the slurry throughout a network of pipelines, a third operation of one or more valves configured to distribute the slurry throughout the network of pipelines, a fourth operation of a mixing tank configured to prepare the slurry, a fifth operation of an injection system configured to control an injection of the slurry into the subsurface region, or any combination thereof.

5. The method of claim 1, wherein at least one of the one or more components comprises a mixing tank, and wherein the one or more operations comprise mixing one or more fluids with the slurry.

6. The method of claim 5, wherein the one or more fluids comprise salt water, fresh water, oily drains, production water, or any combination thereof.

7. The method of claim 1, wherein the one or more mechanical properties comprise one or more locations of one or more geological layers within the subsurface region, one or more stresses within the one or more geological layers, one or more Young's modulus values associated with the one or more geological layers, one or more leak-off values associated with the one or more geological layers, one or more formation coefficients associated with the one or more geological layers, one or more pore pressures associated with the one or more geological layers, one or more fluid pressures associated with the one or more geological layers, one or more vertical stresses associated with the one or more geological layers, or any combination thereof.

8. The method of claim 1, wherein the one or more operations are associated with an injection rate in which the slurry is being injected into the subsurface region, a shut-in time, a volume of the slurry, an overflush volume, a viscosity of the slurry, a density of the slurry, an average particle size associated with the slurry, or any combination thereof.

9. A system, comprising:
a wellbore within a subsurface region of the Earth having one or more formations;
an injection system configured to control an injection of a slurry into the wellbore, wherein the slurry comprises waste material;
one or more sensors configured to acquire data associated with one or more properties of the slurry and one or more operations of the injection system; and
one or more processors configured to:
receive the data;
perform a comparison of the data with respect to simulated data generated using a geomechanical model associated with the subsurface region and the CRI operation with respect to the subsurface region; and
automatically adjust operation of the injection system based on the comparison.

10. The system of claim 9, comprising a mixing tank configured to prepare the slurry, wherein the processor is configured to send a second set of commands to a controller configured to operate the mixing tank based on the comparison, wherein the second set of commands is configured to adjust the one or more properties of the slurry.

11. The system of claim 10, wherein the processors are configured to continuously generate the geomechanical model based on the data based on the comparison.

12. The system of claim 11, wherein the processors are configured to continuously adjust the operation of the injection system based on the geomechanical model that is continuously generated based on the data.

13. The system of claim 10, wherein the injection system comprises a pump configured to:
control an injection rate in which the slurry is pumped into the wellbore;
control a volume of the slurry being pumped into the wellbore; or
any combination thereof.

14. The system of claim 10, comprising a mechanism configured to filter solids from drilling fluids extracted from the wellbore, wherein the one or more processors are configured to control an operation of the mechanism based on the comparison.

15. The system of claim 10, wherein the data comprises one or more geomechanical properties associated with one or more geological layers of the subsurface region.

16. A non-transitory computer-readable medium comprising computer-executable instructions configured to cause one or more processors to:
generate one or more simulated values associated with a subsurface region of the Earth based on a geomechanical model of the subsurface region, wherein the geomechanical model is configured to perform a simulation of injecting a slurry into the subsurface region via a wellbore, and wherein the geomechanical model comprises one or more geomechanical properties within the subsurface region;
receive data from one or more sensors disposed within the subsurface region, wherein the first set of data corresponds to at least one of the one or more geomechanical properties;
generate an updated geomechanical model based on the data if the data exceeds a predetermined threshold of the one or more simulated values;
confirm that the geomechanical model is accurate if the data is within the predetermined threshold of the one or more simulated values; and
automatically control an injection of the slurry into the subsurface region based on the updated geomechanical model to adjust one or more properties associated with the injection of the slurry.

17. The non-transitory computer-readable medium of claim 16, wherein the one or more properties comprise an injection rate of the slurry, a volume of the slurry, a density of the slurry, a viscosity of the slurry, or any combination thereof.

18. The non-transitory computer-readable medium of claim 16, wherein the one or more controllers are configured to control an operation of a mixing tank configured to prepare the slurry.

19. The non-transitory computer-readable medium of claim 16, wherein the data and at least one of the simulated values comprise a downhole pressure of the wellbore.

20. The method of claim 17, wherein the one or more sensors comprise a viscometer, a densitometer, or both.
